(19) United States
(12) Patent Application Publication
(10) Pub. No.: US 2010/0287844 A1
(43) Pub. Date: Nov. 18, 2010

(54) DOOR

(76) Inventor: John Ian Rhys Harrison, Pembrokeshire (GB)

Correspondence Address: MERCHANT & GOULD PC, P.O. BOX 2903, MINNEAPOLIS, MN, 55402-0903, US

(21) Appl. No.: 12/094,021

(22) PCT Filed: Dec. 7, 2007
(86) PCT No.: PCT/GB2007/004696

§ 371 Date: Aug. 3, 2010

(30) Foreign Application Priority Data
Dec. 8, 2006 (GB) 0624563.3

(51) Int. Cl. E06B 7/18; E06B 7/16

(52) U.S. Cl. 49/480.1; 49/506

(57) ABSTRACT

The invention relates to, but not exclusively to, a door or window including a sealing arrangement.

The invention provides a door or window 1 movable between an open position and a closed position where the, wherein the door or window 1 comprises a first face 4 and a second face 5, and a resiliently deformable strip 6 located at least partially between the first face and second face. When the door or window 1 is in the closed position, the resiliently deformable strip 6 is movable between a sealing position, in which the resiliently deformable strip 6 is in sealing contact with a perimeter of the door or window opening, and an unsealed position, in which the resiliently deformable strip 6 is not in sealing contact with the said perimeter. The door or window further comprises at least one pressure bar 17 for moving the resiliently deformable strip 6 between the sealing position and the unsealed position.

This invention relates to, but not exclusively to, a door or window including a sealing arrangement.

It is often desirable when closing a door or window to seal the opening being blocked by the door or window to air and/or water. Various situations in which this may become desirable include a safe door, to protect whatever is being kept inside from water damage in case of a flood; for a fire door, to restrict the flow of air feeding a fire; for an external door of a building, to help protect against flood damage; for doors and/or windows in an archive storage facility, to protect documents from water or air damage; or for doors and/or windows to protect against possible gas leaks in hazardous environments or gas attacks in vulnerable locations and many other situations as the skilled man will appreciate.

One way of creating such a seal is to make the door or window with very tight tolerances so that it only just fits into the opening that it is used to block. However, there are problems with this approach. The door or window may expand or shrink due to temperature variations or water ingress, making the door or window too big to fit the opening, or leaving a gap through which air or water may pass. Also, over time, the door or window will wear down and the tolerance increase, with the resultant problem that air or water may pass through the gap.

The present invention seeks to mitigate at least one of the above mentioned disadvantages.

The present invention provides a movable structure (such as a door or a window) for closing off an opening, the movable structure movable between an open position where the opening is not closed off and a closed position where the opening is substantially closed off, wherein the movable structure comprises a first face and a second face, and a resiliently deformable strip located at least partially between the first face and second face such that, when the movable structure is in the closed position, the resiliently deformable strip is movable between a sealing position, in which the resiliently deformable strip is in sealing contact with a perimeter of the opening, and an unsealed position, in which the resiliently deformable strip is not in sealing contact with the said perimeter, wherein the movable structure further comprises at least one pressure bar for moving the resiliently deformable strip between the sealing position and the unsealed position. Preferably, the pressure bar is located between the first and second face of the movable structure. The pressure bar may act to push the resiliently deformable strip outwards from the movable structure to move it into sealing contact with the opening. Preferably, there is a plurality of pressure bars, creating an even pressure on the resiliently deformable strip.

The movable structure may comprise a plurality of sides, wherein each of the sides is independently sealable.

Advantageously, the movable structure is a door or a window. The perimeter of the opening may be a door frame. The door may be a roller shutter door, a double door, revolving door or any other suitable type of door. The movable structure may be made of any suitable material, including plastic, upvc, wood, metal or glass. The perimeter of the opening may be a window frame. Advantageously, the movable structure closes off the opening and seals it, such that it becomes airtight. Advantageously, the movable structure closes off the opening and seals it, such that it becomes watertight. The movable structure may close off an opening in such a way as to create a flood protective barrier. The movable structure may close off an opening in such a way as to create an airtight barrier which will help prevent the spread of fire in a building. The movable structure may close off an opening in such a way as to prevent the spread of harmful gasses in a building.

The resiliently deformable strip may extend around the circumference of the movable structure. Advantageously, if the resiliently deformable strip extends around the whole of the circumference of the movable structure no other sealing mechanisms are required to seal off the opening.

Preferably, the movement of the resiliently deformable strip between the sealing position and unsealed position is controlled by a key mechanism. Alternatively, the movement of the resiliently deformable strip is controlled by a plurality of key mechanisms. The key mechanism(s) may be a simple key mechanism which may be inserted into a lock and rotated to move the resiliently deformable strip between the sealing position and the unsealed position. The invention may remove the need for a door or window to be fitted with a conventional lock. Preferably, in the sealing position the resiliently deformable strip prevents the movable structure from being opened.

Alternatively, the movement of the resiliently deformable strip between the sealing position and the unsealed position may be controlled by one or more handles attached to the movable structure. The handle(s) may be attached to the movable structure such that is rotatable, wherein its rotation moves the resiliently deformable strip between the sealing position and the unsealed position. The movement of the resiliently deformable strip may be controlled by a combination of a handle and a key mechanism, such that the resiliently deformable strip may be locked in either the sealing position or the unsealed position.

Advantageously, the resiliently deformable strip is located fully within the first and second face when in the unsealed position. The resiliently deformable strip is then protected from damage when the movable structure is in the open position.

The resiliently deformable strip may be comprised of a plastic material. The resiliently deformable strip may be a rubber, for example neoprene.

The pressure bars may act indirectly on the resiliently deformable strip by means of an actuating element adjacent to the resiliently deformable strip. The actuating element may run the length of a side of the movable structure. There may be a plurality of actuating elements, one for each side of the movable structure. In order that the movable structure can provide an even seal at the corners of an opening, there may be a corner fitting where one actuating element meets another actuating element. The corner fitting may be interconnected with a first and second actuating element via male and female couplings, such that the corner fitting can move in both the direction the first actuating element can be moved and the direction the second actuating element can be moved.

Preferably the movable structure has at least one actuating element associated with the resiliently deformable strip, wherein the actuating element comprises a plurality of interconnected sections. Preferably, the interconnected sections are arranged to move at least part of the resiliently deformable strip into the sealing position by expansion of the interconnecting sections, such that the overlap between two adjacent interconnecting portions is reduced. Advantageously, the interconnected sections include a male and female portion. Advantageously, the male portion of one interconnected section is received in the female section of an adjacent interconnected section. Advantageously, the interconnecting sections evenly stretch the resiliently deformable strip when the movable structure is in the sealing position, thereby creating a consistent seal. The actuating element may be expanded by a pressure bar and contracted when the pressure bar no longer acts upon it due to the resilience of the resiliently deformable strip. Alternatively, the actuating element may be retracted when the pressure bar acts to pull the actuating element inwards, rather than pushing it outwards.

Advantageously, the actuating element comprises at least five interconnecting sections. Further advantageously, at least ten interconnecting sections. Advantageously, the greater the number of interconnecting sections the more consistently the resiliently deformable strip is stretched.

The invention also provides a method of sealing an opening, including the steps of:

providing a movable structure as described above,

moving the movable structure to the closed position, and

moving the resiliently deformable strip to the sealing position.

The movement of the resiliently deformable strip from the unsealed position to the sealed position may be via the use of one or more key mechanisms or due to the movement of one or more handles.

The invention further provides a kit of parts, comprising a resiliently deformable strip that may be retrofitted to a movable structure, such as a door or a window, to produce a movable structure as described above.

An embodiment of the invention will now be described, by way of example only, with reference to the accompanying schematic drawings of which:

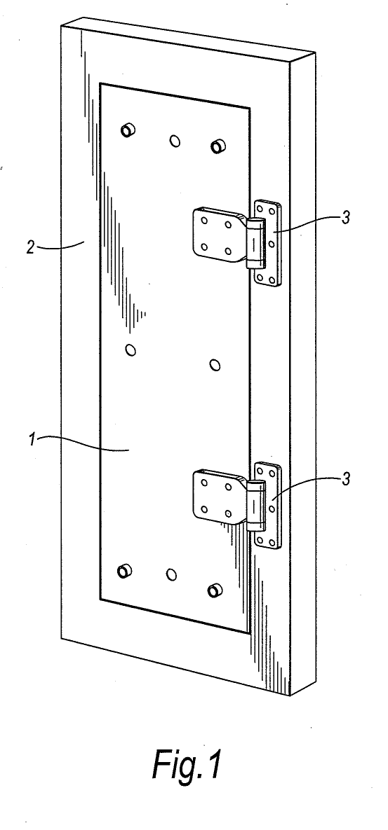

FIG. 1 is a diagram of a first embodiment, showing a door according to the invention in the closed position;

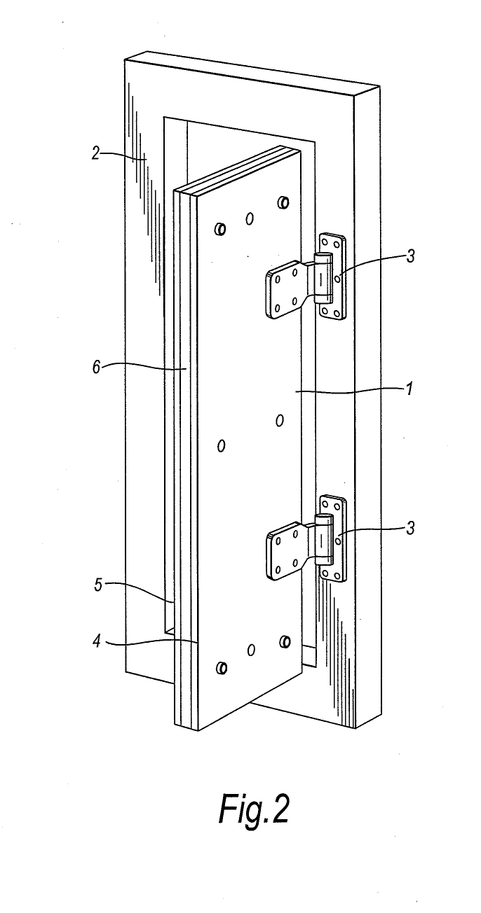

FIG. 2 is the embodiment as shown in FIG. 1 shown in the open position;

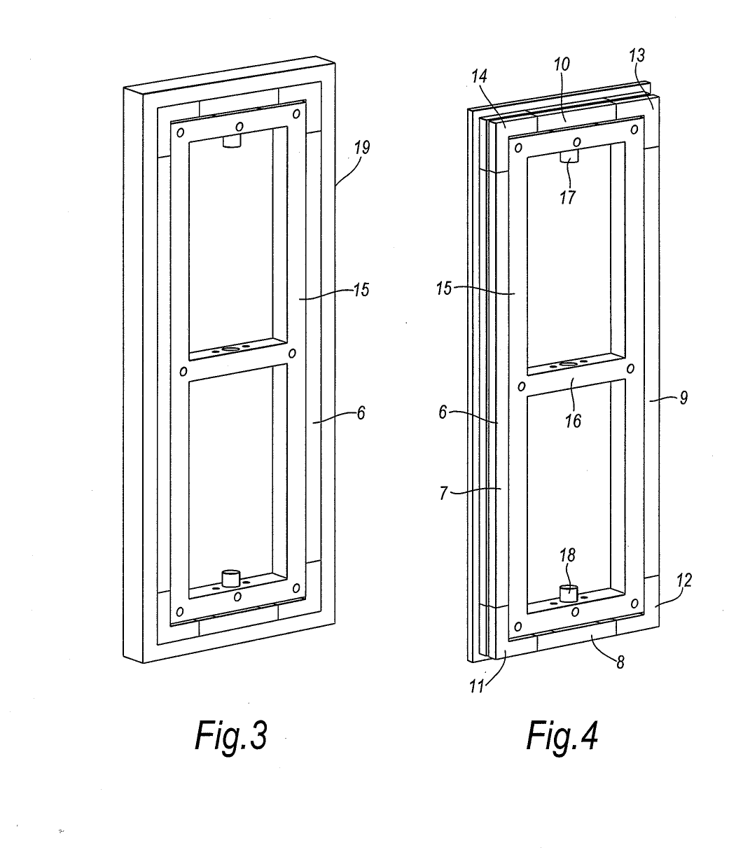

FIG. 3 is a cut away view of the first embodiment as shown in FIG. 1;

FIG. 4 is a further cut away view of the first embodiment as shown in FIG. 1;

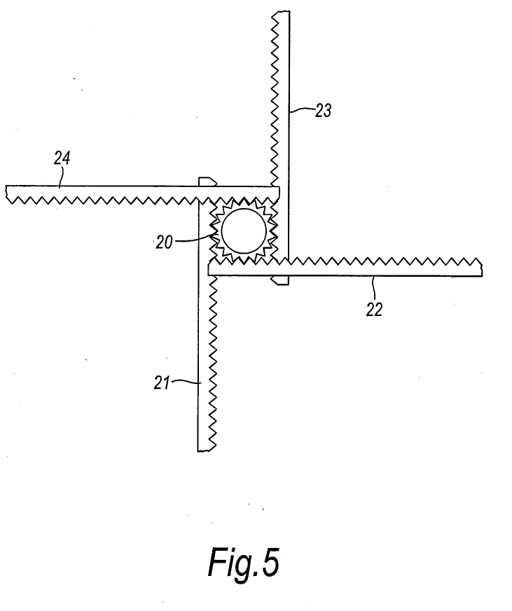

FIG. 5 shows an arrangement that may be used to operate the pressure bars shown in the first embodiment;

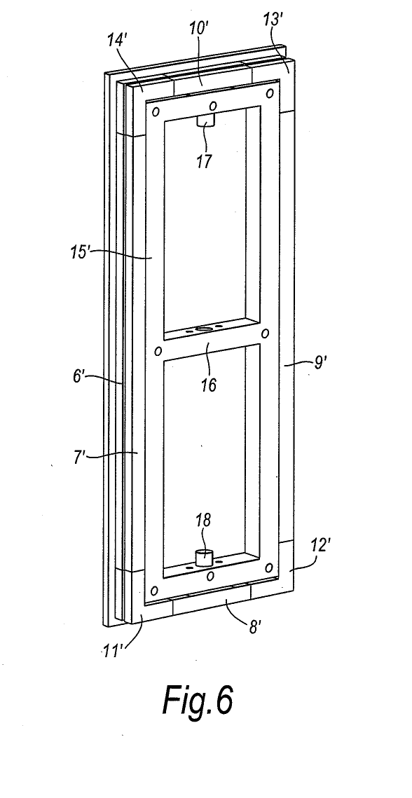

FIG. 6 shows a second embodiment of the invention;

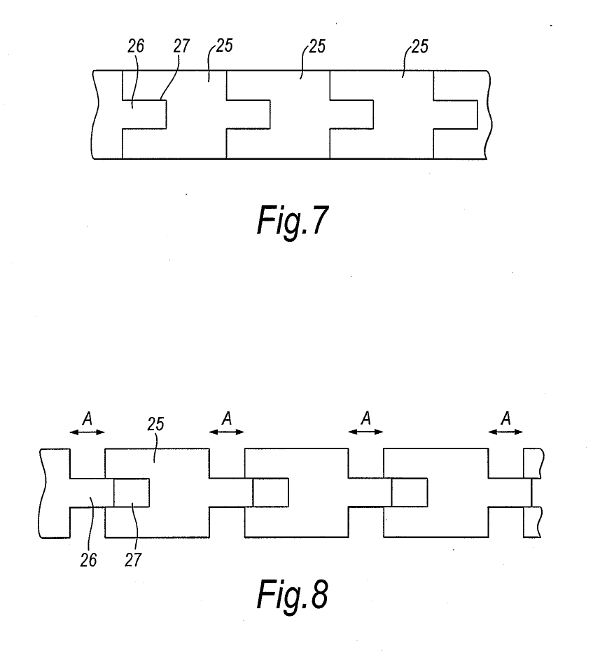

FIG. 7 shows a third embodiment of the invention when in the unsealed position; and

FIG. 8 shows the third embodiment of the invention when in the sealed position.

FIG. 1 shows a door 1, situated within a frame 2 and movably attached to the frame 2 by hinges 3. The door 1 is in the closed position, blocking off the opening, the perimeter of which is defined by the frame 2.

FIG. 2 shows the door 1 in an open position, such that it is not blocking off the opening defined by the frame 2. As can be seen, the door 1 is movably attached to the frame 2 by the hinges 3 such that it may pivot between the open and closed positions. The door 1 comprises a first face 4 and a second face 5 with a resiliently deformable rubber strip 6 located between the first face 4 and second face 5, such that it runs around the whole circumference of the door 1.

When the door is in the open position (as shown in FIG. 2), the resiliently deformable strip is fully located between the first face 4 and second face 5. Advantageously, should anything hit the edge of the door 1 it does not damage the resiliently deformable rubber strip 6 because the rubber strip 6 is protected by the edges of the first face 4 and second face 5. When the door 1 is in the closed position (as shown in FIG. 1) the resiliently deformable rubber strip 6 may be moved between a sealing position and an unsealed position. In the sealed position, the resiliently deformable rubber strip 6 is expanded outwards (by twisting a handle rotatably attached to the door 1—not shown) such that it comes in to sealing contact with the frame 2. When the resiliently deformable rubber strip 6 is in sealing contact with the frame 2 it restricts the passage of air or water between the door 1 and the frame 2. The strength of the sealing contact is dependent on the pressure exerted between the frame 2 and the resiliently deformable rubber strip 6. The greater the pressure between them, the greater air and/or water pressure it may resist. To move the resiliently deformable rubber strip 6 from the sealed position to the unsealed position, the handle rotatably attached to the door 1 (not shown) is twisted in the opposite direction and the resiliently deformable rubber strip 6 moves from the sealing position back to the position located within the first face 4 and second face 5. FIG. 5 shows in more detail a possible arrangement for moving the resiliently deformable rubber strip 6 between the sealed and unsealed position. The door 1 may then be moved between the open position and closed position in a normal manner.

FIGS. 3 and 4 show in more detail the internal construction of the door, and are shown with the first face 4 and second face 5 removed. FIG. 3 shows the door while situated within a frame 19, which defines the perimeter of the opening the door closes off. FIG. 4 shows the door with the frame 19 excluded. The resiliently deformable rubber strip 6 comprises four straight sections, 7, 8, 9, and four corner sections, 11, 12, 13 and 14, all arranged around an inner frame 15. The inner frame includes a horizontal cross bar 16, approximately halfway between the top and bottom of the inner frame 15. Within the top and bottom of the inner frame 15, there are pressure bars, 17 and 18. Also included, but not shown, are pressure bars within the horizontal cross bar 16. These pressure bars are moved back and forth by the rotating handle, as described above, and act to push the resiliently deformable rubber strip 6 from an unsealed position to a sealed position.

Alternatively, a separate handle and/or lock mechanism may be associated with each pressure bar so they are individually operable.

FIG. 5 shows the arrangement used to operate all of the pressure bars, those within the horizontal cross bar 16, and the pressure bars 17, and 18, through the use of a single handle. The handle is attached to the driving cog 20, which is engaged with four toothed bars, 21, 22, 23 and 24 which are associated with their respective pressure bars. When the handle, hence the driving cog, is moved in an anticlockwise direction the bars 21, 22, 23 and 24 are moved outwards, pushing on the pressure bars and expanding the resiliently deformable rubber strip 6 into the sealed position. When the handle is moved in a clockwise direction the bars 21, 22, 23, and 24 are moved inwards, pulling back the pressure bars and the resiliently deformable rubber strip 6 back to the unsealed position.

In an alternative embodiment, the straight sections shown in FIGS. 3 and 4 as 7, 8, 9, 10, and four corner sections shown in FIGS. 3 and 4 as 11, 12, 13, 14, are rigid sections which act as actuating elements with a male/female interconnection between the corner sections and the adjacent straight sections. An endless strip of resiliently deformable material extends around the straight sections and corner sections in such a way that when the pressure bars are moved they push the straight sections and corner sections out, expanding the resiliently deformable material into the sealed position.

FIG. 6 shows the rigid straight sections 7′, 8′, 9′, and 10′, and the rigid corner sections as 11′, 12′, 13′, and 14′, and the resiliently deformable strip around the circumference of the door as 6′, the movement into the sealing position goes as follows.

The pressure bar 17 pushes the straight section 10′ upwards and away from the door. The corner sections 13′ and 14′ also move upwards and away from the door. The resiliently deformable strip 6′ adjacent to the straight section 10′ and the top parts of the corner sections 13′ and 14′ is moved into the sealing position, pushing against the perimeter of the opening. It will be appreciated that as the corner sections 13′ and 14′ move upwards they stretch the resiliently deformable strip adjacent to the sides 7′ and 9′ of the door, with the majority of the stretching occurring where the corner fittings 13′ and 14′ join the straight sections 7′ and 9′. A pressure bar within the horizontal cross bar 16 acts in a similar way on the side section 7′, pushing the side section 7′ and corner fittings 11′ and 14′ sideways and away from the door. The corner fittings 11′ and 14′ therefore stretch the resiliently deformable strip 6′ adjacent to the top straight section 10′ and bottom straight section 8′, with the majority of the stretching occurring where the corner fittings 11′ and 14′ join the straight sections 8′ and 10′. It will be understood by the skilled person that the other sides of the door are sealed in the same way, with the resiliently deformable strip 6 being stretched in the corresponding places.

FIGS. 7 and 8 show a further embodiment of the invention. The arrangement is similar to that described above in relation to FIG. 6, where the straight sections 7′, 8′, 9′, 10′ and four corner sections 11′, 12′, 13′, 14′ are rigid and surrounded by an endless strip of resiliently deformable material 6′. However, the rigid sections are replaced by sections made up of a plurality of segments 25. Each segment 25 includes a male protrusion 26 and a female cavity 27, wherein the male protrusion 26 of one segment is arranged to be received in the female cavity 27 of an adjacent segment. In a similar way to the above described embodiments, pressure bars are used to push out the plurality of segments 25.

However, each of the segments 25 each move a limited distance, indicated by the arrows A in FIG. 8, each segment expanding the resiliently deformable strip 6′ a small amount in the vicinity of that segment. Therefore, the endless strip of resiliently deformable material is expanded consistently and the seal created in the sealing position is of constant pressure around the opening being sealed.

Whilst the present invention has been described and illustrated with reference to particular embodiments, it will be appreciated by those of ordinary skill in the art that the invention lends itself to many different variations not specifically illustrated herein. For example, the movable structure may be a window instead of a door. Also, the movable structure may be slideably movable, rather than pivotally movable as described above.

The resiliently deformable strip may be moved between the sealing position and unsealed position by a key mechanism instead of a handle. The movable structure may comprise a plurality of sides, each of these sides independently sealable. Alternatively a key mechanism could be combined with a handle such that the resiliently deformable strip may be locked in either the sealing position or unsealed position. The resiliently deformable strip may be made out of a rubber material, or any other material with the required level of resilience. For that reason, reference should be made to the claims for determining the true scope of the present invention.

1. A movable structure for closing off an opening, the movable structure movable between an open position wherein the opening is not closed off and a closed position where the opening is substantially closed off, wherein the movable structure comprises a first face and a second face, and a resiliently deformable strip located at least partially between the first face and second face such that, when the movable structure is in the closed position, the resiliently deformable strip is movable between a sealing position, in which the resiliently deformable strip is in sealing contact with a perimeter of the opening, and an unsealed position, in which the resiliently deformable strip is not in sealing contact with the said perimeter, wherein the movable structure further comprises at least one pressure bar for moving the resiliently deformable strip between the sealing position and the unsealed position.

2. A movable structure as claimed in claim 1, wherein the resiliently deformable strip extends around the circumference of the movable structure.

3. A movable structure as claimed in claim 1, wherein the movement of the resiliently deformable strip between the sealing position and unsealed position is controlled by a key mechanism.

4. A movable structure as claimed in claim 1, wherein the resiliently deformable strip is movable between the sealing position and unsealed position as a result of the actuation of a handle.

5. A movable structure as claimed in claim 1, wherein the resiliently deformable strip is located fully within the first and second face when in the unsealed position.

6. A movable structure as claimed in claim 1, wherein the movable structure is a door.

7. A movable structure as claimed in claim 1, wherein the movable structure is a window.

8. A movable structure as claimed in claim 1, wherein the resiliently deformable strip comprises rubber.

9. A movable structure as claimed in claim 1, wherein the at least one pressure bar is arranged to move the resiliently deformable strip between the sealing position and unsealed position by acting upon an actuating element adjacent to the resiliently deformable seal.

10. A movable structure as claimed in claim 9, wherein the actuating element comprises a plurality of interconnected sections.

11. A movable structure as claimed in claim 10, wherein each of the interconnected sections comprises a male protrusion and female cavity.

12. A method of sealing an opening, including the steps of:
providing a movable structure, the movable structure movable between an open position where the opening is not closed off and a closed position where the opening is substantially closed off, wherein the movable structure comprises a first face and a second face, and a resiliently deformable strip located at least partially between the first face and second face such that, when the movable structure is in the closed position, the resiliently deformable strip is movable between a sealing position, in which the resiliently deformable strip is in sealing contact with a perimeter of the opening, and an unsealed position, in which the resiliently deformable strip is not in sealing contact with the said perimeter, the movable structure further comprising at least one pressure bar for moving the resiliently deformable strip between the sealing and unsealed position,
moving the movable structure to the closed position, and
moving the resiliently deformable strip to the sealing position.

13. A method of sealing an opening as claimed in claim 12, wherein the resiliently deformable strip is moved to the sealing position by actuation of a key mechanism.

14. A method of sealing an opening as claimed in claim 12, wherein the resiliently deformable strip is moved to the sealing position by the movement of a handle.

15. A kit of parts comprising a resiliently deformable strip that may be retrofitted to a movable structure such that a movable structure as claimed in claim 1 results.

16.-17. (canceled)
